(19) United States
(12) Patent Application Publication
(10) Pub. No.: US 2014/0223275 A1
(43) Pub. Date: Aug. 7, 2014

(54) Method of File Sharing for Portable Mobile Devices

(71) Applicant: InfoPower Corporation, Taipei (TW)

(72) Inventors: Jer-Bin Lin, New Taipei City (TW); Che-Yu Lee, New Taipei City (TW); Chun-Lin Chen, Tainan City (TW)

(73) Assignee: InfoPower Corporation, Taipei (TW)

(21) Appl. No.: 14/174,846

(22) Filed: Feb. 7, 2014

Related U.S. Application Data
(60) Provisional application No. 61/762,292, filed on Feb. 7, 2013.

(51) Int. Cl. G06F 3/0482; G06F 17/30

(52) U.S. Cl. CPC G06F 3/0482; G06F 17/30011
USPC 715/205; 715/753

(57) ABSTRACT

For sharing, viewing and downloading of contents through a mobile device, a file management and sharing program is installed on the mobile device. The file management and sharing program is able to link the mobile device to a backend server having a privately accessible memory a team may use to save a plurality of shared contents. A user may access the privately accessible memory by registering as a member of the team. The user may select at least one content from a memory only accessible to the user to share the at least one content to the team. The user may select a shared content from the plurality of shared content to view. The user may at least one shared content from the privately accessible memory of the team and download the at least one shared content to the memory accessible to the user.

### CROSS REFERENCE TO RELATED APPLICATION

This non-provisional application claims priority of U.S. provisional application 61/762,292 filed on Feb. 7, 2013.

### BACKGROUND OF THE INVENTION

1. Field of the Invention

The present invention relates to a method of file sharing for portable mobile devices, and more particularly, a method of file sharing and managing a plurality of contents to a team and a method of viewing a shared content of a team member.

2. Description of the Prior Art

There are a growing number of users for mobile devices such as smart phones and tablets. The ability to create, view, and access files using mobile devices is becoming a necessity. In the work place, the ability to share files between team members is an important factor for team collaboration. Sharing of files also has social applications such as sharing of media files between friends and family.

### SUMMARY OF THE INVENTION

An embodiment of the present invention discloses a method of file sharing. The method comprises installing and running a file management and sharing program on a mobile device; linking the mobile device to a backend server; displaying a plurality of categories, a plurality of sub-categories of one of the categories, and thumbnails of contents of the sub-categories on a first interface of user interface of the file management and sharing program; displaying a plurality of shared categories on a second interface of user interface of the file management and sharing program; selecting a first category from the plurality of categories; selecting a sub-category from a plurality of sub-categories of the first category; selecting at least one content from the sub-category; and adding the at least one content to a shared sub-category of one of the plurality of shared categories or a shared sub-category of a new shared category.

Another embodiment of the present invention discloses a method of file sharing. The method comprises installing and running a file management and sharing program on a mobile device; linking the mobile device to a backend server; displaying a plurality of categories, a plurality of sub-categories of one of the categories, and thumbnails of contents of the sub-categories on a first interface of user interface of the file management and sharing program; displaying a plurality of shared categories on a second interface of user interface of the file management and sharing program; selecting a shared category from the plurality of shared categories; selecting a shared sub-category from a plurality of shared sub-categories of the shared category; displaying a plurality of shared contents of the shared sub-category; selecting a shared content from the plurality of shared contents; and opening the shared content.

Another embodiment of the present invention discloses a method of file downloading. The method comprises installing and running a file management and sharing program on a mobile device; linking the mobile device to a backend server; displaying a plurality of categories, a plurality of sub-categories of one of the categories, and thumbnails of contents of the sub-categories on a first interface of user interface of the file management and sharing program; displaying a plurality of shared categories on a second interface of user interface of the file management and sharing program; selecting a first shared category from the plurality of shared categories; selecting a shared sub-category from a plurality of shared sub-categories of the first shared category; selecting at least one content from the shared sub-category; and adding the at least one content to a sub-category of one of the plurality of categories or a sub-category of a new category.

Another embodiment of the present invention discloses a method of file sharing. The method comprises installing and running a file management and sharing program on a mobile device; linking the mobile device to a backend server; displaying a plurality of categories, a plurality of sub-categories of one of the categories, and thumbnails of contents of the sub-categories on an interface of user interface of the file management and sharing program; selecting a category from the plurality of categories; selecting a sub-category from a plurality of sub-categories of the category; selecting at least one content from the sub-category; storing a copy of the at least one content from the sub-category in the backend server; and generating a share link for the at least one content.

Another embodiment of the present invention discloses a method of file downloading. The method comprises selecting a share link; installing and running a file management and sharing program on a mobile device; linking the mobile device to a backend server; downloading at least one content corresponding to the share link from the backend server; adding the at least one content to a new sub-category of a new category; and displaying a plurality of categories, the new category, the new sub-category of the new category, and at least one thumbnail of the at least one content of the new sub-category on an interface of user interface of the file management and sharing program.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a first interface of a user interface of a file management and sharing program on a mobile device according to a first embodiment of the present invention.

FIG. 2 illustrates a second interface of the user interface of the file management and sharing program on the mobile device according to a second embodiment of the present invention.

FIG. 3 illustrates a flowchart of a method of file sharing according to the present invention.

FIG. 4 illustrates a flowchart of a method of viewing a shared content of a team member according to the present invention.

FIG. 5 illustrates a flowchart of a method of file downloading to a privately accessible memory according to the present invention.

FIG. 6 illustrates a flowchart of the method of file sharing to selected members according to the present invention.

FIG. 7 illustrates a flowchart of the method of file downloading to the privately accessible memory from a share link according to the present invention.

### DETAILED DESCRIPTION

The present invention discloses a method of file sharing, viewing, and downloading for portable mobile device. Note that the mobile device may be a smart pad or a smart phone in the embodiments of the present invention.

A file management and sharing program is utilized for performing the method of file sharing, viewing, and downloading for portable mobile device according to the present invention. The user must install the file management and sharing program on to a mobile device.

The user of the file management and sharing program shall link and register to a backend server. The user must also be registered as a member of at least one team in order to share, view, and download contents to the team through the file management and sharing program.

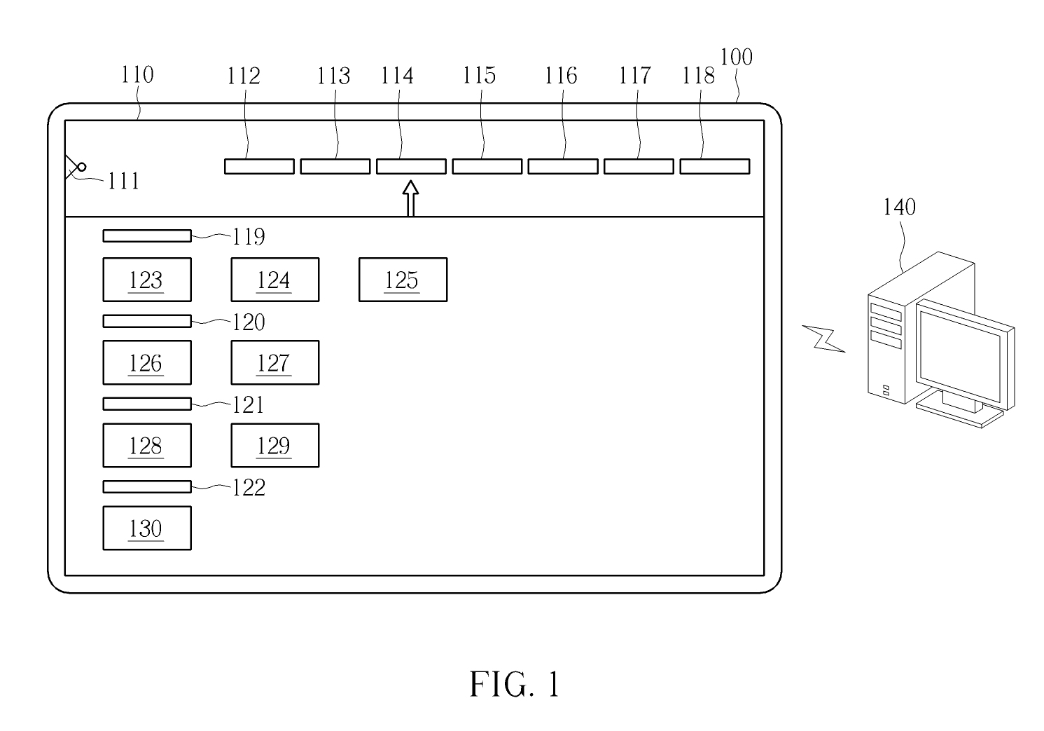

Please refer to FIG. 1. FIG. 1 illustrates a first interface of a user interface 110 of the file management and sharing program on a mobile device 100 according to a first embodiment of the present invention. The first interface of the user interface 110 comprises a plurality of icons 111 to 113, a plurality of categories 114 to 118, a plurality of sub-categories 119 to 122, and a plurality of thumbnails 123 to 130. Each of the thumbnails corresponds to a content that may refer to a file, an image, a video, or a web-address saved in a memory only accessible to the user that may be a memory of the mobile device 100 and/or a personal cloud memory. Each of the categories contains at least one sub-category that has at least one content. The number of the categories, the number of the sub-categories and the number of the contents are not limited by the file management and sharing program.

Each of the icons 111 to 113 displayed on the first interface of the user interface 110 corresponds to a command that the file management and sharing program shall execute when selected. Commands to be executed after selection of an icon may include opening a web browser or linking and downloading a plurality of contents from a backend server 140. A plurality of categories of the file management and sharing program corresponds to a major grouping of a plurality of contents saved in the memory only accessible to the user, i.e., sports, news, coupons, documents, videos, and/or images. Under each of the plurality of categories, there is at least one sub-category. A sub-category is a subset of a category, i.e., a news category include sub-categories including CNN, NBC and/or BBC. Each sub-category has at least one content, i.e., under a news category is a sub-category which may be a CNN sub-category and under the CNN sub-category may be articles and/or images. The plurality of thumbnails corresponds to the plurality of contents saved in the memory only accessible to the user. When a thumbnail is selected, a command will be executed to open a content corresponding to the selected thumbnail.

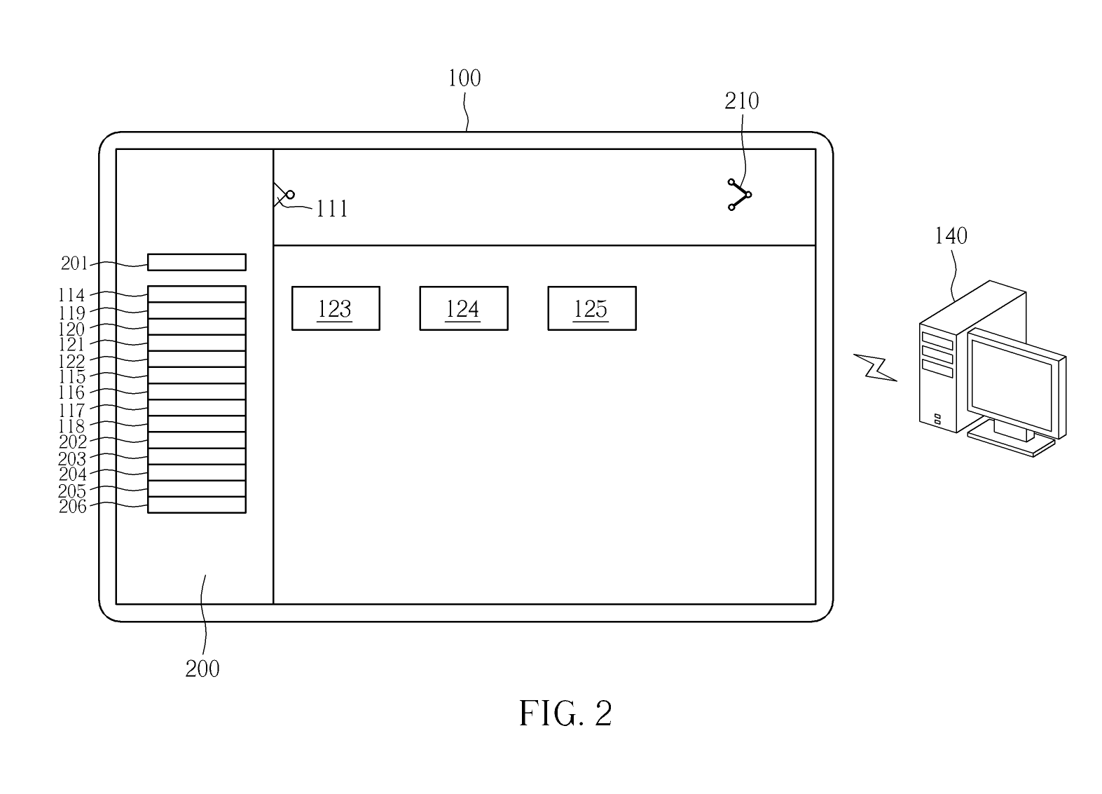

Please refer to FIG. 2. FIG. 2 illustrates a second interface of the user interface 110 of a file management and sharing program on a mobile device 100 according to a second embodiment of the present invention. The second interface of the user interface comprises the icon 111, the plurality of categories 114 to 118, the plurality of sub-categories 119 to 122, the plurality of thumbnails 123 to 125, a sidebar 200, an add category option 201, a shared label 202, and a plurality of shared categories 203 to 206.

An icon displayed on all domain interfaces of the user interface 110 is a tag icon 111. Referring to the user interface 110 in FIG. 1, when the tag icon 111 of the first interface is dragged, a sidebar 200 shall appear in the user interface 110 as shown in FIG. 2. Initial display of the sidebar 200 shall include the plurality of categories 114 to 118, the plurality of sub-categories 119 to 122, the plurality of thumbnails 123 to 125, the sidebar 200, the add category option 201, the shared label 202 and the plurality of shared categories 203 to 206.

Initial display of the second domain of the user interface 110 will prompt the file management and sharing program to display the thumbnails under a first sub-category of the category displayed in the first domain of the user interface 110 before the tag icon 111 was dragged. As shown in FIG. 2, the plurality of thumbnails 123 to 125 are displayed in the second domain of the user interface 110, which is a group of thumbnails under a first sub-category 119 under a first category 114 as shown in the first domain of the user interface 110. The shared label 202 is used as a divider between the plurality of categories 114 to 118 and the plurality of shared categories 203 to 206.

The user may choose from a plurality of thumbnails from the plurality of categories to be shared to the team by performing drag and drop on the plurality of thumbnails. By dragging of at least one thumbnail above a shared category, the shared category shall show a plurality of shared sub-categories under the shared category. The user may choose from one of the shared sub-categories the plurality of thumbnails is added to. If the user drops the plurality of thumbnails on the shared category, then a new shared sub-category under the shared category is formed containing the plurality of thumbnails. If the user drops the plurality of thumbnail on the shared label 202 or an empty space under the shared label 202, then a new shared category is formed having a new shared sub-category containing the plurality of thumbnails. If drag and drop is performed on a category to be dropped on or under the shared label 202, a new shared category is created having contents identical to that of the category of origin. Naming of categories, sub-categories, shared categories, shared sub-categories, and thumbnails may be user defined or program default.

When a thumbnail is placed under a shared category, the content that corresponds to the thumbnail is sent to the backend server 140. The content shall be saved under a privately accessible memory of the backend server 140 that has been allocated to the team. The access to the privately accessible memory is limited to a plurality of users registered in the backend server 140 under the team.

All the contents that have been shared through the file management and sharing program by the user shall be accessible to other members under the same team. And shared contents by other members of the teams shall be accessible to the user. If the user chooses not to view a shared content by another member, the user may set the shared content as invisible.

When the file management and sharing program is initialized, the mobile device 100 shall link to the backend server 140. The file management and sharing program shall download links to the shared contents of the plurality of teams wherein the user is a member of . The contents are divided into shared categories set by the members of the teams that have shared the contents. One way the shared categories may be viewed is in the second interface of user interface 110 under the shared label 202.

To view a particular shared content, the user may select a shared category from the plurality of shared categories 203 to 206. Then a shared sub-category is to be selected from a plurality of shared sub-categories of the shared category. A plurality of shared contents of the shared sub-category is then displayed through corresponding plurality of thumbnails. A shared content is selected from the plurality of shared contents by selecting the corresponding thumbnail. If the shared content is located in the backend server 140, a download command may be sent to the backend server 140 to initialize transmission of data to the mobile device 100.

To download and save permanently at least one shared content, the user may choose from a plurality of thumbnails from the plurality of shared categories to be downloaded by performing drag and drop on the plurality of thumbnails. By dragging of at least one thumbnail above a category, the category shall show a plurality of sub-categories under the category. The user may choose from one of the sub-category the plurality of thumbnails is added to. If the user drops the plurality of thumbnails on the category, then a new sub-category is formed containing the plurality of thumbnails. If the user drops the plurality of thumbnails on the add category option 201, then a new category is formed having a new sub-category containing the plurality of thumbnails. If drag and drop is performed on a shared category to be dropped on or under the add category option 201, a new category is created having contents identical to that of the shared category of origin. Naming of categories, sub-categories, shared categories, shared sub categories, and thumbnails may be user defined or program default.

When a thumbnail is placed under a category, the content that corresponds to the thumbnail is saved permanently to the memory only accessible to the user.

If the user wants to share the contents to selected members, the user may choose from a plurality of thumbnails from the plurality of categories to be shared to the selected members by selecting the plurality of thumbnails and then selecting a share icon 210 on the second interface of the user interface 110. By selecting the share icon 210, the file management and sharing program shall send and save the contents that correspond to the thumbnails to the backend server 140. A share link for linking to the backend server 140 and accessing the contents is generated. The share link may be sent to the selected members through networks, e.g. Facebook, Twitter, Gmail, Hotmail, etc.

The user may also share a category or a sub-category to selected members. The category or the sub-category may be selected by performing dragging on the category or the sub-category on the second interface of the user interface 110. After selecting the category or the sub-category a share option shall appear. When the share option is selected, the category or the sub-category is sent and saved to the backend server 140. A share link for linking to the backend server 140 and accessing the category or the sub-category is generated. The share link may be sent to the selected members through networks.

When a selected member selects the share link, the selected member may be directed to the user interface 110 of the file management and sharing program. The contents corresponding to the share link shall be placed under a new sub-category of a new category. The contents may be saved permanently to the memory only accessible to the selected member. Each of the contents shall be represented by a thumbnail. When the share link corresponds to a sub-category, the sub-category may be added as a new sub-category of a new category of the file management and sharing program. The sub-category may be saved permanently to the memory only accessible to the selected member. When the share link corresponds to a category, the category may be added as a new category of the file management and sharing program. The category may be saved permanently to the memory only accessible to the selected member.

When the selected member access the share link on a mobile device 100 without the file management and sharing program, the file management and sharing program may be sent to the mobile device for installation. After the file management and sharing program is installed and run in the mobile device 100, the mobile device 100 may link to the backend server 140. The contents corresponding to the share link shall be placed under a new sub-category of a new category. The contents may be saved permanently to the memory only accessible to the selected member. Each of the contents shall be represented by a thumbnail.

If the user chooses not to install the file management and sharing program, the user may still view the contents through a browser. The user may download the contents by clicking on an open button on the browser.

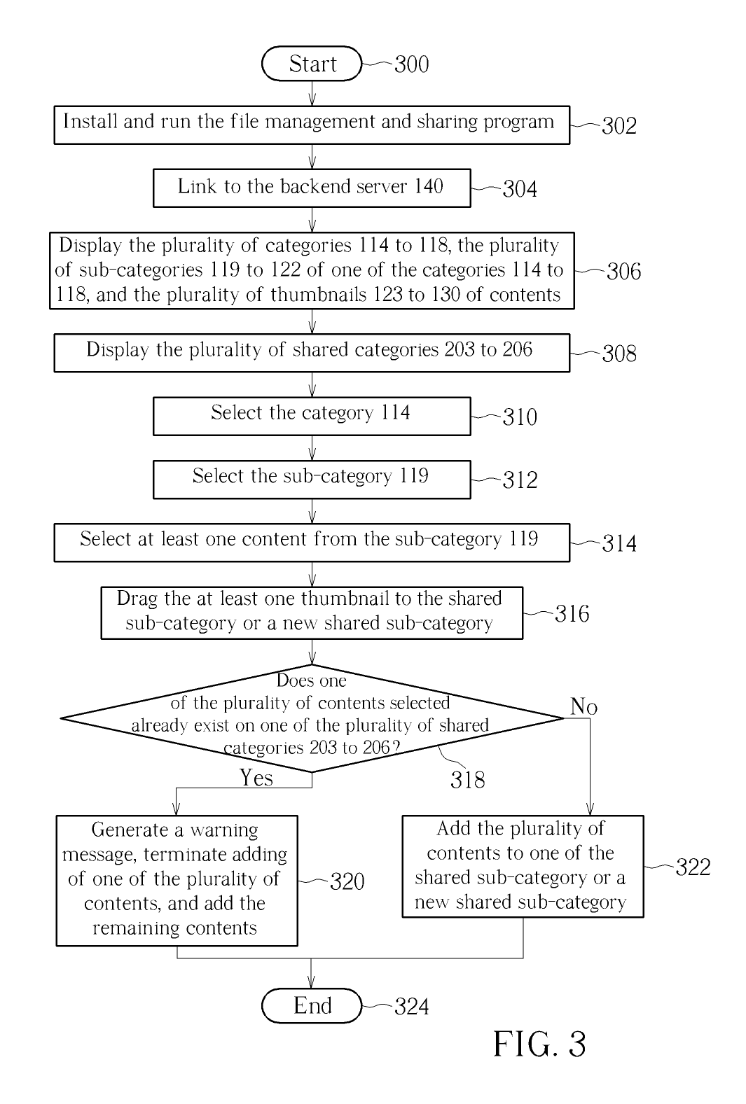

Please refer to FIG. 3. FIG. 3 illustrates a flowchart of the method of file sharing according to the present invention. As shown in FIG. 3, the method of file sharing may include and is not limited to the following steps:

Step 300: start;

Step 302: Install and run the file management and sharing program on the mobile device 100;

Step 304: Link the mobile device 100 to the backend server 140;

Step 306: Display the plurality of categories 114 to 118, the plurality of sub-categories 119 to 122 of one of the categories 114 to 118, and the plurality of thumbnails 123 to 130 of contents under the sub-categories 119 to 122 on the first interface of user interface 110 of the file management and sharing program;

Step 308: Display the plurality of shared categories 203 to 206 on the second interface of user interface 110 of the file management and sharing program after dragging the tag icon 111;

Step 310: Select the category 114 from the plurality of categories 114 to 118;

Step 312: Select the sub-category 119 from the plurality of sub-categories 119 to 122 of the category 114;

Step 314: Select at least one content from the sub-category 119 by selecting corresponding thumbnail;

Step 316: Drag the at least one thumbnail to the shared sub-category of one of the plurality of shared categories 203 to 206 or a new shared sub-category of a new shared category;

Step 318: Does one of the plurality of contents selected already exist on one of the plurality of shared categories 203 to 206? If so, go to Step 320; else perform Step 322;

Step 320: The file management and sharing program generates a warning message, terminates adding of one of the plurality of contents to one of the plurality of shared categories 203 to 206, and adds the remaining contents of the plurality of contents to one of the plurality of shared categories 203 to 206; go to Step 324;

Step 322: Add the plurality of contents to one of the shared sub-category of one of the plurality of shared categories 203 to 206 or a new shared sub-category of a new shared category;

Step 324: end.

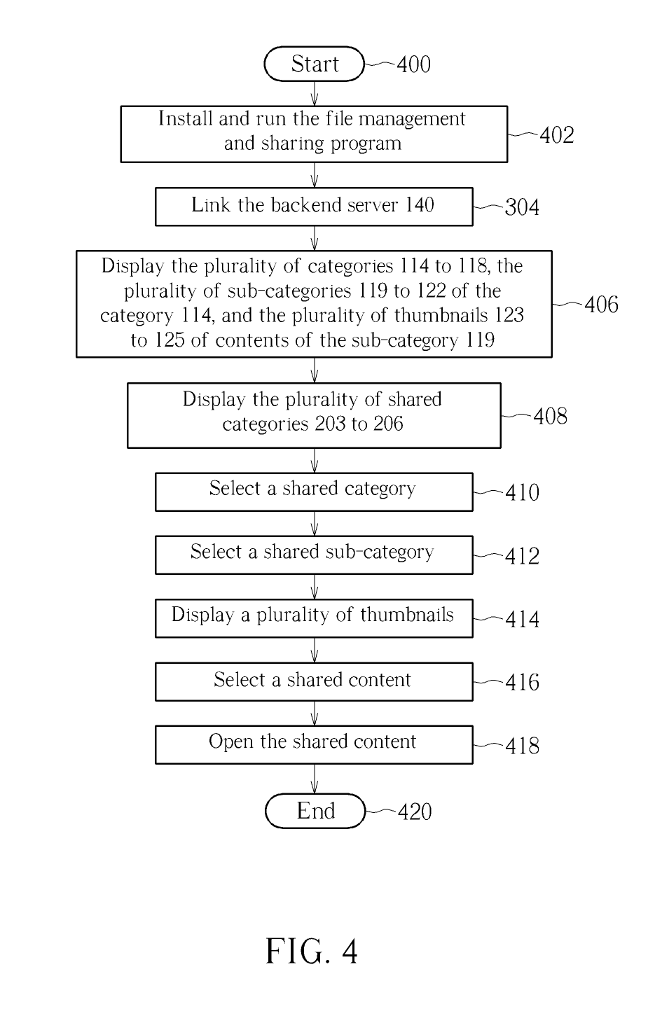

Please refer to FIG. 4. FIG. 4 illustrates a flowchart of the method of viewing a shared content of a team member according to the present invention. As shown in FIG. 4, the method of viewing a shared content may include and is not limited to the following steps:

Step 400: start;

Step 402: Install and run the file management and sharing program on the mobile device 100;

Step 404 : Link the mobile device 100 to the backend server 140;

Step 406: Display the plurality of categories 114 to 118, the plurality of sub-categories 119 to 122 of the category 114, and the plurality of thumbnails 123 to 125 of contents of the sub-category 119 on the second interface of user interface 110 of the file management and sharing program;

Step 408: Display the plurality of shared categories 203 to 206 on the second interface of user interface 110 of the file management and sharing program;

Step 410: Select a shared category from the plurality of shared categories 203 to 206;

Step 412: Select a shared sub-category from a plurality of shared sub-categories of the shared category;

Step 414: Display a plurality of thumbnails corresponding to a plurality of respective shared contents of the shared sub-category;

Step 416: Select a shared content by selecting a thumbnail from the plurality of thumbnails;

Step 418: Open the shared content;

Step 420: end.

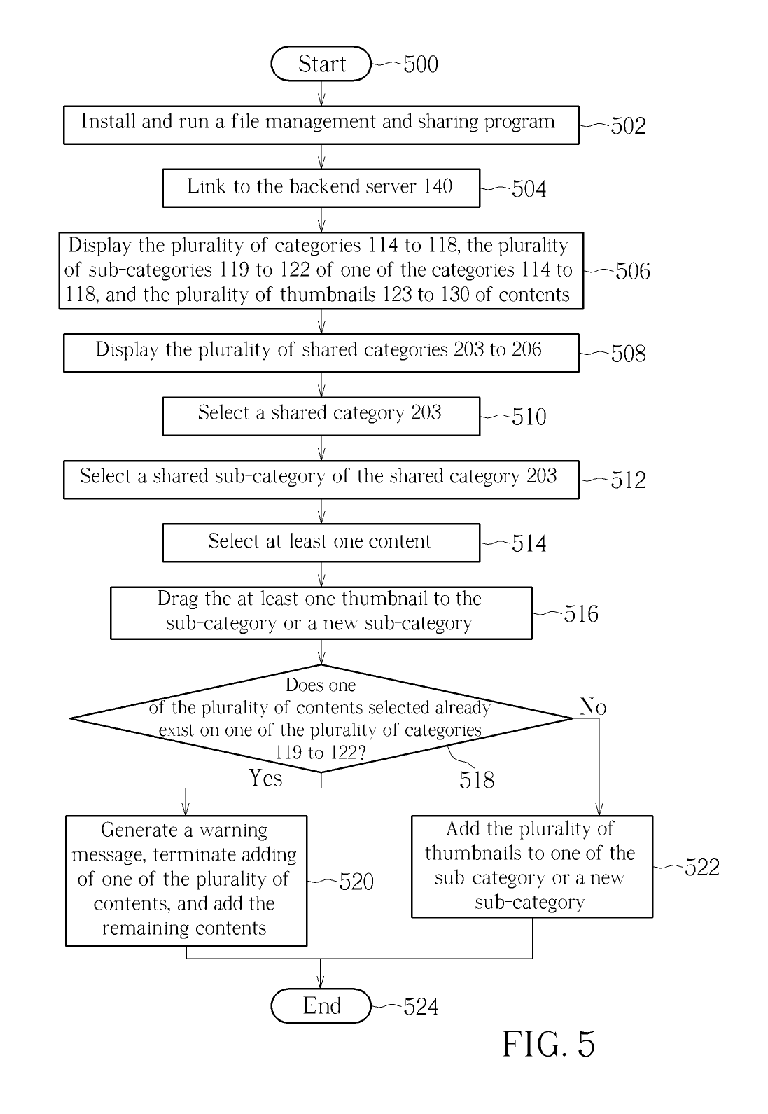

Please refer to FIG. 5. FIG. 5 illustrates a flowchart of the method of file downloading to the privately accessible memory according to the present invention. As shown in FIG. 5, the method of file downloading may include and is not limited to the following steps:

Step 500: start;

Step 502: Install and run the file management and sharing program on the mobile device 100;

Step 504: Link the mobile device 100 to the backend server 140;

Step 506: Display the plurality of categories 114 to 118, the plurality of sub-categories 119 to 122 of one of the categories 114 to 118, and the plurality of thumbnails 123 to 130 of contents under the sub-categories 119 to 122 on the first interface of user interface 110 of the file management and sharing program;

Step 508: Display the plurality of shared categories 203 to 206 on the second interface of user interface 110 of the file management and sharing program after dragging the tag icon 111 on the first interface of user interface 110;

Step 510: Select a shared category 203 from the plurality of shared categories 203 to 206;

Step 512: Select a shared sub-category from a plurality of shared sub-categories of the shared category 203;

Step 514: Select at least one content from the shared sub-category by selecting corresponding thumbnail;

Step 516: Drag the at least one thumbnail to the sub-category of one of the plurality of categories 119 to 122 or a new sub-category of a new category;

Step 518: Does one of the plurality of contents selected already exist on one of the plurality of categories 119 to 122? If so, go to Step 520; else perform Step 522;

Step 520: The file management and sharing program generates a warning message, terminates adding of one of the plurality of contents to one of the plurality of categories 119 to 122, and adds the remaining contents of the plurality of contents to one of the plurality of categories 119 to 122; go to Step 524;

Step 522: Add the plurality of thumbnails to one of the sub-category of one of the plurality of categories 119 to 122 or a new sub-category of a new category;

Step 524: end.

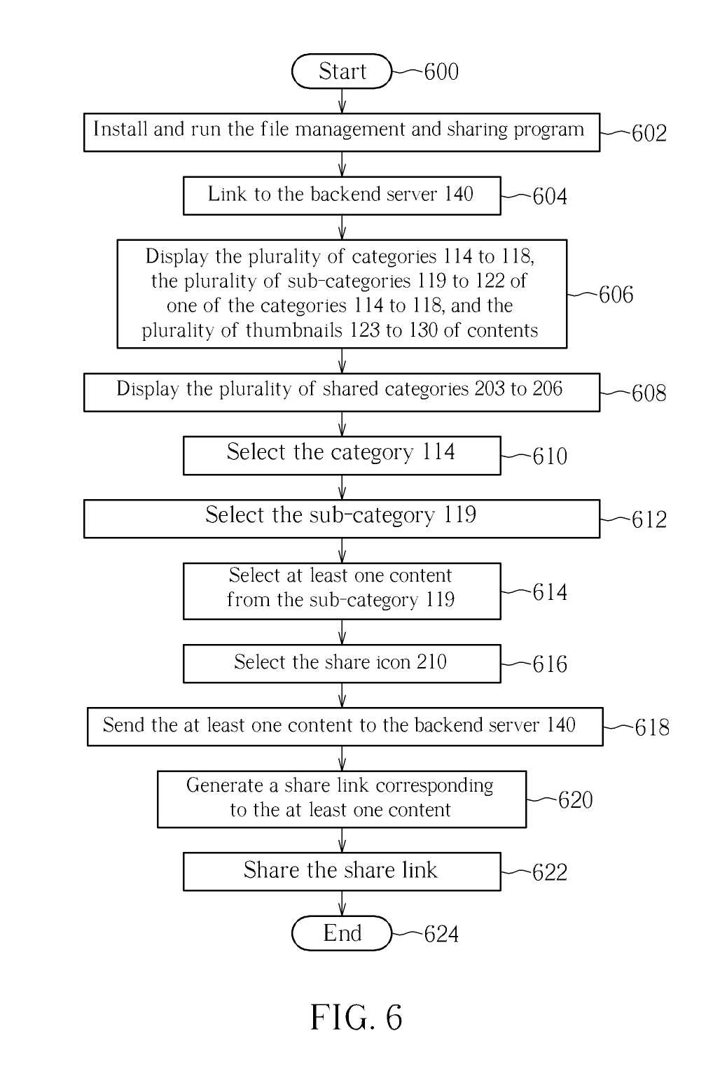

Please refer to FIG. 6. FIG. 6 illustrates a flowchart of the method of file sharing to selected members according to the present invention. As shown in FIG. 6, the method of file sharing to selected members may include and is not limited to the following steps:

Step 600: start;

Step 602: Install and run the file management and sharing program on the mobile device 100;

Step 604 : Link the mobile device 100 to the backend server 140;

Step 606: Display the plurality of categories 114 to 118, the plurality of sub-categories 119 to 122 of one of the categories 114 to 118, and the plurality of thumbnails 123 to 130 of contents under the sub-categories 119 to 122 on the first interface of user interface 110 of the file management and sharing program;

Step 608: Display the plurality of shared categories 203 to 206 on the second interface of user interface 110 of the file management and sharing program after dragging the tag icon 111;

Step 610: Select the category 114 from the plurality of categories 114 to 118;

Step 612: Select the sub-category 119 from the plurality of sub-categories 119 to 122 of the category 114;

Step 614: Select at least one content from the sub-category 119 by selecting corresponding thumbnail;

Step 616: Select the share icon 210;

Step 618: Send the at least one content to the backend server 140;

Step 620: Generate a share link corresponding to the at least one content at the backend server 140;

Step 622: Share the share link to the selected members through sending the share link to the selected members through a network;

Step 624: end.

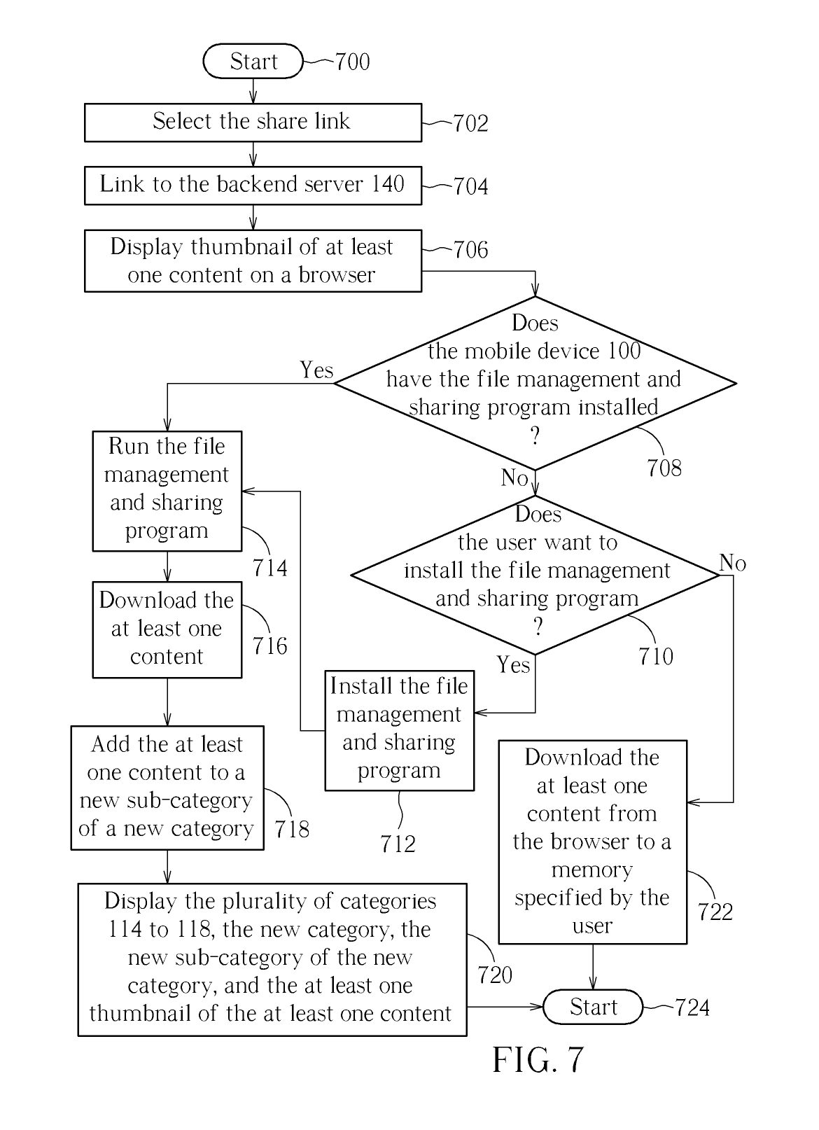

Please refer to FIG. 7. FIG. 7 illustrates a flowchart of the method of file downloading to the privately accessible memory from a share link according to the present invention. As shown in FIG. 7, the method of file downloading from a share link may include and is not limited to the following steps:

Step 700: start;

Step 702: Select the share link;

Step 704: Link the mobile device 100 to the backend server 140;

Step 706: Display thumbnail of at least one content corresponding to the share link on a browser while maintaining the category and sub-category structure of the at least one content;

Step 708: Does the mobile device 100 have the file management and sharing program installed? If not, go to Step 710; else perform Step 714;

Step 710: Does the user want to install the file management and sharing program? If so, go to Step 712; else perform Step 722;

Step 712: Install the file management and sharing program on the mobile device 100;

Step 714: Run the file management and sharing program on the mobile device 100;

Step 716: Download the at least one content corresponding to the share link from the backend server 140 to the privately accessible memory;

Step 718: Add the at least one content to a new sub-category of a new category;

Step 720: Display the plurality of categories 114 to 118, the new category, the new sub-category of the new category, and the at least one thumbnail of the at least one content under the new sub-category on the first interface of user interface 110 of the file management and sharing program; Go to Step 724;

Step 722: Download the at least one content from the browser to a memory specified by the user;

Step 724: end.

The file management and sharing program of the present invention disclosed allows a user to share contents to members of at least one team the user is a member of. Also view and/or download contents of at least one privately accessible memory of the backend server 140 designated to teams that the user is registered as a member to. The file management and sharing program allows the user to save, share, download, and view several types of contents including document file, URL, image file, and video file.

The user has the option of having a shared content repeatedly shared under any shared category preferred by the user. The user may view a shared content by selecting a thumbnail corresponding to the shared report under a shared category. The mobile device 10 is linked to the backend server 140 to view the shared content. By downloading from the privately accessible memory of the backend server 140, the user may be able to access file even though the mobile device 100 is not linked to the backend server 140. The at least one content downloaded from the backend server 140 may be saved in a memory only accessible to the user that may be a memory of the mobile device a personal cloud memory and/or a privately accessible memory of the backend server 140. The privately accessible memory of the may refer to a memory in the backend server that is only accessible to users that are registered members in the backend server 140. Contents saved in the backend server 140 under a registered member in the backend server 140 will not be accessible to other registered members. Contents saved in the backend server 140 under a registered team in the backend server 140 will only be accessible to registered members of the team and not be accessible to registered members of other registered teams.

The file management and sharing program gives the user access to a plurality of privately accessible memory designated to corresponding teams the user is registered as a member. The user is also given the option of choosing preferred shared contents using an invisible setting of the file management and sharing program. The user may set at least one shared category, at least one shared sub-category and/or at least one shared contents to be invisible if the user prefers to do so.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of file sharing, comprising:
installing and running a file management and sharing program on a mobile device;
linking the mobile device to a backend server;
displaying a plurality of categories, a plurality of sub-categories of one of the categories, and thumbnails of contents of the sub-categories on a first interface of user interface of the file management and sharing program;
displaying a plurality of shared categories on a second interface of user interface of the file management and sharing program;
selecting a first category from the plurality of categories;
selecting a sub-category from a plurality of sub-categories of the first category;
selecting at least one content from the sub-category; and
adding the at least one content to a shared sub-category of one of the plurality of shared categories or a shared sub-category of a new shared category.

2. The method of claim 1, further comprising:
selecting a second category from the plurality of categories; and
adding a new shared category having identical contents as the second category.

3. The method of claim 1, further comprising:
registering a user of the file management and sharing program to the backend server; and
registering the user to at least one team registered in the backend server so as to access the plurality of shared categories.

4. The method of claim 1, wherein adding the at least one content to the shared sub-category of one of the plurality of shared categories or the shared sub-category of the new shared category is performing drag and drop on the at least one content to add the at least one content to the shared sub-category of one of the plurality of shared categories or the shared sub-category of the new shared category.

5. The method of claim 1, wherein the plurality of categories are stored in the mobile device, a personal cloud memory accessible by the mobile device, and/or a privately accessible memory of the backend server.

6. The method of claim 1, wherein the plurality of shared categories are stored in a privately accessible memory of the backend server according to a team a user of the file management and sharing program is registered to.

7. The method of claim 1, further comprising if one of the at least one content already exist on one of the plurality of shared categories, generating a warning message.

8. A method of file sharing, comprising:
installing and running a file management and sharing program on a mobile device;
linking the mobile device to a backend server;
displaying a plurality of categories, a plurality of sub-categories of one of the categories, and thumbnails of contents of the sub-categories on a first interface of user interface of the file management and sharing program;
displaying a plurality of shared categories on a second interface of user interface of the file management and sharing program;
selecting a shared category from the plurality of shared categories;
selecting a shared sub-category from a plurality of shared sub-categories of the shared category;
displaying a plurality of shared contents of the shared sub-category;
selecting a shared content from the plurality of shared contents; and
opening the shared content.

9. The method of claim 8, further comprising:
registering a user of the file management and sharing program to the backend server; and
registering the user to at least one team registered in the backend server so as to access the plurality of shared categories.

10. The method of claim 8, wherein the plurality of categories are stored in the mobile device, a personal cloud memory accessible by the mobile device, and/or a privately accessible memory of the backend server.

11. The method of claim 8, wherein the plurality of shared categories are stored in a privately accessible memory of the backend server according to a team a user of the file management and sharing program is registered to.

12. The method of claim 8, further comprising classifying at least one of the plurality of shared contents as invisible.

13. A method of file downloading, comprising:
installing and running a file management and sharing program on a mobile device;
linking the mobile device to a backend server;
displaying a plurality of categories, a plurality of sub-categories of one of the categories, and thumbnails of contents of the sub-categories on a first interface of user interface of the file management and sharing program;
displaying a plurality of shared categories on a second interface of user interface of the file management and sharing program;
selecting a first shared category from the plurality of shared categories;
selecting a shared sub-category from a plurality of shared sub-categories of the first shared category;
selecting at least one content from the shared sub-category; and
adding the at least one content to a sub-category of one of the plurality of categories or a sub-category of a new category.

14. The method of claim 13, further comprising:
selecting a second shared category from the plurality of shared categories; and
adding a new category having identical contents as the second shared category.

15. The method of claim 13, further comprising:
registering a user of the file management and sharing program to the backend server; and
registering the user to at least one team registered in the backend server so as to access the plurality of shared categories.

16. The method of claim 13, wherein adding the at least one content to the sub-category of one of the plurality of categories or the sub-category of the new category is performing drag and drop on the at least one content to add the at least one content to the sub-category of one of the plurality of categories or the sub-category of the new category.

17. The method of claim 13, wherein the plurality of categories are stored in the mobile device, a personal cloud memory accessible by the mobile device, and/or a privately accessible memory of the backend server.

18. The method of claim 13, wherein the plurality of shared categories are stored in a privately accessible memory of the backend server according to a team a user of the file management and sharing program is registered to.

19. The method of claim 13, further comprising if one of the at least one content already exist on one of the plurality of categories, generating a warning message.

20. A method of file sharing, comprising:
installing and running a file management and sharing program on a mobile device;
linking the mobile device to a backend server;
displaying a plurality of categories, a plurality of sub-categories of one of the categories, and thumbnails of contents of the sub-categories on an interface of user interface of the file management and sharing program;
selecting a category from the plurality of categories;
selecting a sub-category from a plurality of sub-categories of the category;
selecting at least one content from the sub-category;
storing a copy of the at least one content from the sub-category in the backend server; and
generating a share link for the at least one content.

21. The method of claim 20, further comprising:
storing a copy the sub-category in the backend server; and
generating a share link for the sub-category.

22. The method of claim 20, further comprising:
storing a copy the category in the backend server; and
generating a share link for the category.

23. The method of claim 20, wherein the plurality of categories are stored in the mobile device, a personal cloud memory accessible by the mobile device, and/or a privately accessible memory of the backend server.

24. A method of file downloading, comprising:
selecting a share link;
linking a mobile device to a backend server;
installing and running a file management and sharing program on the mobile device;
downloading at least one content corresponding to the share link from the backend server;
adding the at least one content to a new sub-category of a new category; and
displaying a plurality of categories, the new category, the new sub-category of the new category, and at least one thumbnail of the at least one content of the new sub-category on an interface of user interface of the file management and sharing program.

25. The method of claim 24, wherein the plurality of categories and the new category are stored in the mobile device, a personal cloud memory accessible by the mobile device, and/or a privately accessible memory of the backend server.
